(19) United States
(12) Patent Application Publication
(10) Pub. No.: US 2023/0087627 A1
(43) Pub. Date: Mar. 23, 2023

(54) Methods of Making Metal-Organic Framework Composites

(71) Applicant: ExxonMobil Technology and Engineering Company, Annandale, NJ (US)

(72) Inventors: Matthew T. Kapelewski, Flemington, NJ (US); Joseph E. Gatt, Annandale, NJ (US); Aaron W. Peters, New Hope, PA (US); Wesley Sattler, Parsippany, NJ (US); Thomas J. Ferro, Glen Gardner, NJ (US)

(21) Appl. No.: 17/904,552

(22) PCT Filed: Jan. 19, 2021
(86) PCT No.: PCT/US2021/013985

§ 371 Date: Aug. 18, 2022

Related U.S. Application Data
(60) Provisional application No. 62/984,897, filed on Mar. 4, 2020.

(51) Int. Cl. B01J 20/22; B01J 20/08; B01J 20/28; B01J 20/26; B01J 20/32

(52) U.S. Cl. CPC B01J 20/226; B01J 20/08; B01J 20/28042; B01J 20/261; B01J 20/262; B01J 20/28059; B01J 20/28061; B01J 20/2808; B01J 20/28083; B01J 20/3204; B01J 20/3214; B01J 20/3265

(57) ABSTRACT

Provided herein are methods of making an adsorbent bed useful as a micro-reactor, or a catalytic and/or separation device. The adsorbent bed comprises a metal-organic framework composite. In the present methods, one or more metal-organic frameworks in powder form are mixed in a liquid to produce a metal-organic framework suspension or other type of metal-organic framework coating. A monolith is coated with the suspension or coating to provide the metal-organic framework composite having at least one metal-organic framework coating layer deposited on and bounded to the monolith. The metal-organic framework composite produced has a BET surface area of about 1 m²/g to about 300 m²/g and/or a comparative BET surface area of about 40% to about 100% relative to the metal-organic framework monolith, and pore size between about 1 nm and about 50 nm.

### FIELD OF INVENTION

The present disclosure generally relates to formulations of metal-organic frameworks, and specifically relates to methods of making metal-organic framework composites having at least one metal-organic framework coating layer deposited on a monolith.

### BACKGROUND OF THE INVENTION

For adsorption applications, materials having large internal surface areas defined by pores and channels are beneficial. Strategies to create such microporous or mesoporous active materials include the use of metal-organic frameworks. Metal-organic frameworks offer several advantages over other types of materials including significant porosity and internal surface area, high volume-to-surface ratios, and excellent separation and catalysis performance and fluid storage. Moreover, the pore size and channel structure of the metal-organic framework can be tailored over large ranges. Furthermore, metal-organic frameworks can be functionalized easily.

Notwithstanding these benefits, appropriate formulation of the metal-organic framework is crucial to various applications. Previous methods include synthesizing the metal-organic framework in powder form and shaping the powder into, for example, membranes, thin-films, pellets, monoliths and foam precursors for industrial applications. But these devices are drastically affected by the intrinsic fragility and poor processability. Furthermore, unlike organic polymers, metal-organic framework crystals are insoluble in any solvents and usually not thermoplastic, meaning traditional solvent- or melting-based processing techniques are not applicable for metal-organic frameworks. Recently, direct ink writing (3-D printing) of pure metal-organic framework monoliths has been suggested. A key challenge to this process, however, is that the material must be made into a suspension having ideal rheological properties with the ability to flow continuously through fine nozzle without clogging (shear thinking).

Therefore, a need exists for methods of making metal-organic framework devices which can maintain the structural integrity of the metal-organic framework without degrading the surface area and porosity advantages such material provides.

### SUMMARY OF THE INVENTION

Provided herein are methods of making an adsorbent bed comprising the steps of: (a) mixing a metal-organic framework in powder form in a liquid to produce a suspension; (b) providing a monolith; (c) dip-coating the monolith in the suspension to produce a metal-organic framework composite having at least one metal-organic framework coating layer deposited on and bounded to the monolith; and (d) drying the metal-organic framework composite to produce an absorbent bed having a BET surface area of about 5 m²/g to about 100 m²/g and pore size between about 1 nm and about 50 nm.

Also, provided herein are methods of making an adsorbent bed comprising the steps of: (a) mixing a metal-organic framework in powder form in a liquid to produce a suspension; (b) providing a monolith; (c) dip-coating the monolith in the suspension to produce a metal-organic framework composite having at least one metal-organic framework coating layer deposited on and bound to the monolith; and (d) drying the metal-organic framework composite to produce an absorbent bed having a comparative BET surface area of about 1% to about 10% relative to the metal-organic framework monolith and a pore size between about 1 nm and about 50 nm in the metal-organic framework and the absorbent bed having macroscopic pores.

Further provided herein are methods of making a metal-organic framework composite useful as an adsorbent bed comprising the steps of: (a) suspending a metal-organic framework powder in a liquid to produce a suspension, wherein the metal-organic framework powder is between about 10 wt. % to about 90 wt. % of the suspension and the suspension does not comprise an acid; (b) washing the suspension onto a substrate to produce a metal-organic framework composite comprising a metal-organic framework coating deposited onto a monolith; and (c) heating the metal-organic framework composite with one or more zeolite to adhere the metal-organic framework coating to the monolith, where the metal-organic framework composite has a BET surface area of about 5 m²/g to about 100 m²/g and/or a comparative BET surface area of about 1% to about 10% relative to the metal-organic framework monolith, and pore size between about 1 nm and about 50 nm.

In addition, methods of making a metal-organic framework composite are provided comprising the steps of: (a) mixing a metal-organic framework powder with a liquid to form a metal-organic framework coating; (b) applying the metal-organic framework coating to a monolith by thermal deposition to produce a metal-organic framework composite, wherein the metal-organic framework coating comprises a percent by weight (wt. %) of metal-organic framework in a liquid in the range of about 30 wt. % to about 60 wt. %; and (c) drying the metal-organic framework composite at a temperature below 250° C. to produce the metal-organic framework composite having a BET surface area of about 5 m²/g to about 100 m²/g and/or a comparative BET surface area of about 1% to about 10% relative to the metal-organic framework monolith, and pore size between about 2 nm and about 50 nm.

In an aspect, the metal-organic framework is HKUST-1, the liquid is ethanol, and the monolith is alumina wash coated cordierite. In an aspect, the metal-organic framework is Mg-MOF-74, the liquid is ethanol, and the monolith is a ceramic. In an aspect, the methods further comprise the step of maturing the metal-organic framework composite at a temperature of about 40° C. to about 150° C. for a period of about 30 minutes or greater. In an aspect, the methods further comprise the step of calcining the metal-organic framework composite at a temperature of about 100° C. to about 300° C. for a period of about 1 hour or greater. In an aspect, the methods further comprise washing the metal-organic framework composite with an optional solvent. In an aspect, the optional solvent is selected from the group of water, methanol, ethanol, dimethylformamide, acetone, diethylether, acetonitrile, ketones, amides, esters, ethers, nitriles, aromatic hydrocarbons, aliphatic hydrocarbons, and combination(s) thereof. In an aspect, the adsorbent bed is a channel reactor for gases and fluids.

In an aspect, the monolith is selected from the group of ceramic, metal, polymeric substrate and/or cellulosic fiber. In an aspect, the monolith is ceramic. In an aspect, the polymeric substrate comprises polyvinyl amide, polyacrylate, polycarbonate, polyamide, polyester, polyether, polyvinyl amine, polyvinyl alcohol, polyvinyl ester, and/or combination(s) thereof.

In an aspect, the metal-organic framework is selected from the group of HKUST-1, UiO-66, ZIF-8, ZIF-7, MIL-100, MOF-74, M₂(m-dobdc), MOF-274, Cu(Qc)₂ and combination(s) thereof.

Further provided herein are channel reactors for gases and fluids comprising at least one layer of a metal-organic framework coating deposited on and bound to a monolith to yield a metal-organic framework composite having a BET surface area of about 5 m²/g to about 200 m²/g and/or a comparative BET surface area of about 1% to about 10% relative to the metal-organic framework monolith, and pore size between about 1 nm and about 50 nm. In an aspect, the monolith of the channel reactor is cordierite. In an aspect, the cordierite is alumina wash coated. In an aspect, the monolith of the channel reactor is predominately alumina.

### BRIEF DESCRIPTION OF THE DRAWINGS

FIG. 1A and FIG. 1B are photograph images of a 400 cpsi square-channeled monolith of ceramic material coated with a formulated HKUST-1 metal-organic framework coating.

FIG. 2 is a micrograph of a monolith of ceramic material having square channels coated with Mg-MOF-74.

FIG. 3 shows micrographs of ceramic monoliths prior to coating.

### DETAILED DESCRIPTION OF THE INVENTION

Before describing the methods of making metal-organic framework composites of the present disclosure in further detail, a listing of terms follows to aid in better understanding the present disclosure.

All numerical values within the detailed description and the claims herein are modified by “about” or “approximately” with respect to the indicated value, and take into account experimental error and variations that would be expected by a person having ordinary skill in the art. Unless otherwise indicated, room temperature is about 25° C.

For the sake of brevity, only certain ranges are explicitly disclosed herein. However, ranges from any lower limit can be combined with any upper limit to recite a range not explicitly recited, as well as, ranges from any lower limit can be combined with any other lower limit to recite a range not explicitly recited, in the same way, ranges from any upper limit can be combined with any other upper limit to recite a range not explicitly recited. Additionally, within a range includes every point or individual value between its end points even though not explicitly recited. Thus, every point or individual value can serve as its own lower or upper limit combined with any other point or individual value or any other lower or upper limit, to recite a range not explicitly recited.

As used in the present disclosure and claims, the singular forms “a,” “an,” and “the” include plural forms unless the context clearly dictates differently.

The term “and/or” as used in a phrase such as “A and/or B” herein is intended to include “A and B,” “A or B,” “A”, and “B.”

The term “aqueous medium” refers to a liquid comprising 5 vol. % water or greater. Suitable aqueous media may comprise or consist essentially of water or mixtures of water and a water-miscible organic solvent.

The term “pre-crystallized” refers to a material, particularly a metal-organic framework material, that is previously synthesized (pre-formed) and typically separated from a reaction medium in which the material was formed.

As used herein, the terms, “metal organic-framework material” or “MOF material” refer to a metal or metalloid and an organic ligand capable of coordination with the metal or metalloid. In certain embodiments, MOF coordination networks of organic ligands and metals (or metalloids) form porous three-dimensional structures.

Generally, metal-organic frameworks (MOFs) are a class of highly porous materials with potential applications in a wide range of fields including gas storage, gas and liquid separations, isomer separation, waste removal, and catalysis, among others. In contrast to zeolites, which are purely inorganic in character, MOFs utilize organic ligands which can function as “struts” bridging metal atoms or clusters of metal atoms together. Like zeolites, MOFs are microporous. The pore shape and size of the MOF can be tuned through selection of the organic ligands and metals. Because organic ligands can be modified, MOFs as a whole are structurally diverse which is different than zeolites. Factors that influence the structure of MOFs include, for example, one or more of ligand denticity, size and type of the coordinating group(s), additional substitution remote or proximate to the coordinating groups, ligand size and geometry, ligand hydrophobicity or hydrophilicity, choice of metal and/or metal salt, choice of solvent, and reaction conditions such as temperature, concentration, and the like.

MOFs are synthesized or obtained commercially as crystalline powder materials. As described above, for many industrial and commercial products, powder-form MOFs can be shaped into larger, coherent bodies having a defined shape that can be desirable. Conventional methods of consolidating powder-form MOFs into large bodies, such as pelletizing and extrusion, often afford less than desirable physical and mechanical properties. More specifically, processing of powder-form MOFs through compaction can result in BET surface areas which are lower than the powder-form MOF due to pressure sensitivity of the MOF structure and relatively low crush strength. Further, certain processing conditions can lead to full or partial phase transformation of the initial MOF structure, as evidenced by x-ray powder diffraction and BET surface area analyses. Each of these factors can be problematic for producing MOFs in the form of shaped bodies and/or using the shaped bodies as a device in various applications.

While it is desirable to consolidate a metal-organic framework (“MOF”) powder into a more coherent (shaped) body, the properties of MOFs, specifically their weakness against pressure and shear, can lead to various issues under pressures (e.g., about 100 psi to several thousand psi) and shear used to consolidate powder-form MOFs, particularly during extrusion. Such processing of the MOF powder can collapse at least a portion of the pores within the MOF structure and lead to an undesirable and oftentimes significant decrease in BET surface area. Moreover, conditions used for consolidating powder-form MOFs into a shaped body can lead to at least partial and sometimes full conversion of the MOF structure into another material, such as another crystalline phase. Consolidated MOFs having poor crush strength can be problematic. For example, poor crush strength values can lead to production of fines, which may be detrimental to certain applications.

Provided herein are methods of making an adsorbent bed useful as a micro-reactor, or a catalytic and/or separation device. The present adsorbent bed comprises a metal-organic framework composite. In the present methods, one or more metal-organic frameworks in powder form are mixed in a liquid to produce a metal-organic framework suspension or other type of metal-organic framework coating such as a suspension. A monolith is coated with the suspension or the metal-organic framework coating to provide the metal-organic framework composite having at least one metal-organic framework coating layer deposited on and/or bound to the monolith. As described herein, the monolith can be two dimensional or three dimensional in shape. The metal-organic framework composite produced has a BET surface area of about 5 m²/g to about 100 m²/g and/or a comparative BET surface area of about 1% to about 10% relative to the metal-organic framework monolith, and pore size between about 1 nm and about 50 nm.

Metal-organic frameworks disclosed herein can be characterized in terms of their porosity. MOFs can include micropores, mesopores, macropores and any combination thereof. Micropores are defined herein as having a pore size of about 2 nm or below, and mesopores are defined herein as having a pore size from about 2 nm to about 50 nm. Interparticle textural porosity cab be present in some instances.

Desirably, metal-organic framework coatings and a metal-organic framework composites made according to the present methods retain at least a substantial portion of the BET surface area of the pre-crystallized metal-organic framework powder from which they are formed. Specifically, these metal-organic framework composites can feature a BET surface area of about 1%, 2%, 3%, 4%, 5%, 6%, 7%, 8%, 9% or 10% or greater relative to the BET surface area of the pre-crystallized metal-organic framework powder material.

As provided herein, the MOF can be ZIFs (or Zeolitic Imidazolate Frameworks), MILs (or Matériaux de l'Institut Lavoisier), and IRMOFs (or IsoReticular Metal Organic Frameworks), alone or combination with other MOFs. In certain embodiments, the MOF is selected from: HKUST-1, MOF-74, MIL-100, ZIF-7, ZIF-8, ZIF-90, UiO-66, UiO-67, MOF-808 or MOF-274.

MOFs can be prepared via combination of an organic ligand, or one or a combination of two or more organic ligands, and a metal or metalloid as described below. For example, MOF-274 is a combination of Mg²⁺, Mn²⁺, Fe²⁺, Zn²⁺, Ni²⁺, Cu²⁺, Co²⁺, or combinations thereof with 4,4-dihydroxy-(1,1′-biphenyl)-3,3′-dicarboxylic acid. Additionally, MOF-274 can include amines coordinated to the metal sites within its structure.

As used herein, an “isotherm” refers to the adsorption of an adsorbate as function of concentration while the temperature of the system is held constant. In an embodiment, the adsorbate is CO₂ and concentration can be measured as CO₂ pressure. As described herein, isotherms can be performed with porous materials and using various mathematical models applied to calculate the apparent surface area. S. Brunauer, P. H. Emmett, and E. Teller. J. Am. Chem. Soc. 1938, 60, 309-319; K. Walton and R. Q. Snurr, J. Am. Chem. Soc. 2007, 129, 8552-8556; I. Langmuir, J. Am. Chem. Soc. 1916, 38, 2221.

### Organic Ligands

As used herein, an organic ligand is a ligand that is monodentate, bidentate, or multi-dentate. The organic ligand can be a single type of ligand, or combination(s) thereof. Generally, the organic ligand is capable of coordination with the metal ion, in principle all compounds can be used which are suitable for such coordination. Organic ligands including at least two centers, which are capable to coordinate the metal ions of a metal salt, or metals or metalloids. In an aspect, an organic ligand includes: i) an alkyl group substructure, having from 1 to 10 carbon atoms, ii) an aryl group substructure, having from 1 to 5 aromatic rings, iii) an alkyl or aryl amine substructure, consisting of alkyl groups having from 1 to 10 carbon atoms or awl groups having from 1 to 5 aromatic rings, where the substructures have at least two functional groups “X”, which are covalently bound to the substructure, and where X is capable of coordinating to a metal or metalloid.

In an aspect, each X is independently selected from neutral or ionic forms of CO₂H, OH, SH, NH₂, CN, HCO, CS₂H, NO₂, SO₃H, Si(OH)₃, Ge(OH)₃, Sn(OH)₃, Sn(SH)₃, PO₃H, CH(RSH)₂, C(RSH)₃, CH(RNH₂)₂, C(RNH₂)₃, CH(ROH)₂, C(ROH)₃, CH(RCN)₂, C(RCN)₃, CH(SH)₂, C(SH)₃, CH(NH₂)₂, C(NH₂)₂, CH(OH)₂, C(OH)₃, CH(CN)₂, C(CN)₃, nitrogen-containing heterocycles, sulfur-containing heterocycles, and combination(s) thereof, where R is an alkyl group having from 1 to 5 carbon atoms, or an awl group consisting of 1 to 2 phenyl rings.

In an aspect, the organic ligand includes substituted or unsubstituted, mono- or polynuclear aromatic di-, tri- and tetracarboxylic acids and substituted or unsubstituted, at least one hetero atom including aromatic di-, tri- and tetracarboxylic acids, which have one or more nuclei.

In an aspect, the organic ligand is benzenetricarboxylate (BTC) (one or more isomers), ADC (acetylene dicarboxylate), NDC (naphtalenedicarboxylate) (any isomer), BDC (benzene dicarboxylate) (any isomer), ATC (adamantanetetracarboxylate) (any isomer), BTB (benzenetribenzoate) (any isomer), MTB (methane tetrabenzoate), ATB (adamantanetribenzoate) (any isomer), biphenyl-4,4′-dicarboxylate, benzene-1,3,5-tris(1H-tetrazole), imidazole, or derivatives thereof, or combination(s) thereof.

Ligands which possess multidentate functional groups can include corresponding counter cations, such as H⁺, Na⁺, K⁺, Mg²⁺, Ca²⁺, Sr²⁺, ammonium ion, alkyl substituted ammonium ions, and aryl substituted ammonium ions, or counteranions, such as F⁻, Cl⁻, Br⁻, I⁻, ClO⁻, ClO₂⁻, ClO₃⁻, ClO₄⁻, OH⁻, NO₃⁻, NO₂⁻, SO₄²⁻, SO₃²⁻, PO₄³⁻, CO₃²⁻, and HCO³⁻

In an aspect, the organic ligands include monodentate functional groups. A monodentate functional group is defined as a moiety bound to a substructure, which can include an organic ligand or amine ligand substructure, L, as defined previously, which can form only one bond to a metal ion. According to this definition, a ligand can contain one or more monodentate functional groups. For example, cyclohexylamine and 4,4′-bipyridine are ligands that contain monodentate functional groups, since each functional group is capable of binding to only one metal ion.

Accordingly, cyclohexylamine is a monofunctional ligand containing a monodentate functional group and 4,4′-bipyridine is a bifunctional ligand containing two monodentate functional groups. Specific examples of ligands containing monodentate functional groups are pyridine, which is a monofunctional ligand, hydroquinone, which is a difunctional ligand, and 1,3,5-tricyanobenzene, which is a trifunctional ligand.

Ligands having monodentate functional groups can be blended with ligands that contain multidentate functional groups to make an MOF in the presence of a suitable metal ion and optionally a templating agent. Monodentate ligands can also be used as templating agents. Templating agents can be added to the reaction mixture for the purpose of occupying the pores in the resulting MOF. Monodentate ligands and/or templating agents can include the following substances and/or derivatives thereof:
A. alkyl or awl amines or phosphines and their corresponding ammonium or phosphonium salts, the alkyl amines or phosphines can include linear, branched, or cyclic aliphatic groups, having from 1 to 20 carbon atoms (and their corresponding ammonium salts), the awl amines or phosphines can include 1 to 5 aromatic rings including heterocycles. Examples of monofunctional amines are methylamine, ethylamine, n-propylamine, iso-propylamine, n-butylamine, sec-butylamine, iso-butylamine, tert-butylamine, n-pentylamine, neo-pentylamine, n-hexylamine, pyrrolidine, 3-pyrroline, piperidine, cyclohexylamine, morpholine, pyridine, pyrrole, aniline, quinoline, isoquinoline, 1-azaphenanthrene, and 8-azaphenanthrene. Examples of difunctional and trifunctional amines are 1,4-diaminocyclohexane, 1,4-diaminobenzene, 4,4′-bipyridyl, imidazole, pyrazine, 1,3,5-triaminocyclohexane, 1,3,5-triazine, and 1,3,5-triaminobenzene.
B. Alcohols that contain alkyl or cycloalkyl groups, containing from 1 to 20 carbon atoms, or aryl groups, containing from 1 to 5 phenyl rings. Examples of monofunctional alcohols are methanol, ethanol, n-propanol, iso-propanol, allyl alcohol, n-butanol, iso-butanol, sec-butanol, tert-butanol, n-pentanol, iso-pentanol, sec-pentanol, neo-pentanol, n-hexanol, cyclohexanol, phenol, benzyl alcohol, and 2-phenylethanol. Examples of difunctional and trifunctional alcohols are 1,4-dihydroxycyclohexane, hydroquinone, catechol, resorcinol, 1,3,5-trihydroxybenzene, and 1,3,5-trihydroxycyclohexane.
C. Ethers that contain alkyl or cycloalkyl groups, containing from 1 to 20 carbon atoms, or aryl groups, containing from 1 to 5 phenyl rings. Examples of ethers are diethyl ether, furan, and morpholine.
D. Thiols that contain alkyl or cycloalkyl groups, containing from 1 to 20 carbon atoms, or awl groups, containing from 1 to 5 phenyl rings. Examples of monofunctional thiols are thiomethane, thioethane, thiopropane, thiocyclohexane, thiophene, benzothiophene, and thiobenzene. Examples of difunctional and trifunctional thiols are 1,4-dithiocyclohexane, 1,4-dithiobertzene, 1,3,5-trithiocyclohexane, and 1,3,5-trithiobenzene.
E. Nitriles that contain alkyl or cycloalkyl groups, containing from 1 to 20 carbon atoms, or awl groups, containing from 1 to 5 phenyl rings. Examples of monofunctional nitriles are acetonitrile, propanenitrile, butanenitrile, n-valeronitrile, benzonitrile, and p-tolunitrile. Examples of difunctional and trifunctional nitriles are 1,4-dinitrilocyclohexane, 1,4-dinitrilobenzene, 1,3,5-trinitrilocyclohexane, and 1,3,5-trinitrilobenzene.
F. Inorganic anions from the group consisting of: sulfate, nitrate, nitrite, sulfite, bisulfite, phosphate, hydrogen phosphate, dihydrogen phosphate, diphosphate, triphosphate, phosphite, chloride, chlorate, bromide, bromate, iodide, iodate, carbonate, bicarbonate, thiocyanide and isonitrile, and the corresponding acids and salts of the aforementioned inorganic anions.
G. Organic acids and the corresponding anions (and salts). The organic acids can include alkyl organic acids containing linear, branched, or cyclic aliphatic groups, having from 1 to 20 carbon atoms, or aryl organic acids and their corresponding aryl organic anions and salts, having from 1 to 5 aromatic rings which can include heterocycles.
H. Other organic and inorganics such as ammonia, carbon dioxide, methane, oxygen, ethylene, hexane, benzene, toluene, xylene, chlorobenzene, nitrobenzene, naphthalene, thiophene, pyridine, acetone, 1-2-dichloroethane, methylenechloride, tetrahydrofuran, ethanolamine, triethylamine or trifluoromethylsulfonic acid.

Additionally, templating agents can include other aliphatic and aromatic hydrocarbons not containing functional groups. In an aspect, templating agents include cycloalkanes, such as cyclohexane, adamantane, or norbomene, and/or aromatics, such as benzene, toluene, or xylenes.

### The Metal Ions

As described above, the MOF can be synthesized by combining metal ions, organic ligands, and optionally a suitable templating agent. Suitable metal ions include metals and metalloids of varying coordination geometries and oxidation states. In an aspect, MOFs are produced using metal ions having distinctly different coordination geometries, in combination with a ligand possessing multidentate functional groups, and a suitable templating agent. MOFs can be prepared using a metal ion that prefers octahedral coordination, such as cobalt (II), and/or a metal ion that prefers tetrahedral coordination, such as zinc (II). MOFs can be made using one or more of the following metal ions: Mg²⁺, Ca²⁺, Sr²⁺, Ba²⁺, Sc³⁺, Y³⁺, Ti⁴⁺, Zr⁴⁺, Hf⁴⁺, V⁵⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, and B⁵⁺, Bi³⁺, Bi⁺, Be²⁺; along with the corresponding metal salt counterion. The term metal ion refers to both metal and metalloid ions. In an aspect, metal ions suitable for use in production of MOFs can include: Sc³⁺, Ti⁴⁺, V⁴⁺, V³⁺, V²⁺, Cr³⁺, Mo³⁺, Mg²⁺, Mn³⁺, Mn²⁺, Fe³⁺, Fe²⁺, Ru³⁺, R²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Al³⁺, Ga³⁺, In³⁺, Ge⁴⁺, Ge²⁺, Sn⁴⁺, Sn²⁺, Pb⁴⁺, Pb²⁺, Sb⁵⁺, Sb³⁺, Sb⁺, and/or Bi⁵⁺, Bi³⁺, Bi⁺, Be²⁺; along with the corresponding metal salt counteranion. In an aspect, metal ions for use in production of MOFs include: Sc³⁺, Ti⁴⁺, V⁴⁺, V³⁺, Cr³⁺, Mo³⁺, Mn³⁺, Mn²⁺, Fe³⁺, Fe²⁺, Co³⁺, Co²⁺, Ni²⁺, Ni⁺, Cu²⁺, Cu⁺, Ag⁺, Zn²⁺, Cd²⁺, Al³⁺, Sn⁴⁺, Sn²⁺, and/or Bi⁵⁺, Bi³⁺, Bi⁺; along with the corresponding metal salt counterion. In an aspect, the metal ions for use in production of MOFs are selected from the group consisting of: Mg²⁺, Mn³⁺, Mn²⁺, Fe³⁺, Fe²⁺, Co³⁺, Co²⁺, Ni²⁺, Ni⁺, Cu²⁺, Cu⁺, Pt²⁺, Ag⁺, and Zn²⁺, along with the corresponding metal salt counterion.

### Preparation of the Metal-Organic Framework

The synthesis of a rigid and stable metal-organic framework (“MOF”) can be carried out under extremely mild reaction conditions. In most cases, the reagents are combined into a solution, either aqueous or nonaqueous, with synthetic reaction temperatures ranging from 0° C. to 100° C. (in an open beaker). In other cases, solution reactions are carried out in a closed vessel at temperatures from 25° C. to 300° C. In either case, large single crystals or microcrystalline microporous solids are formed.

In the preparation of the MOF, the reactants can be added in a mole ratio of 1:10 to 10:1 metal ion to ligand containing multidentate functional groups. In an aspect, the ratio of the metal ion to ligand containing multidentate functional groups is 1:3 to 3:1, such as from 1:2 to 2:1. The amount of templating agent can affect the production of MOF, and in fact, templating agent can in certain circumstances be employed as the solvent in which the reaction takes place. Templating agents can accordingly be employed in great excess without interfering with the reactions and the preparation of the MOF. Additionally, when using a ligand containing monodentate functional groups in combination with the metal ion and the ligand containing multidentate functional groups, the ligand containing monodentate functional groups can be utilized in excess. In certain circumstances the ligand containing monodentate functional groups can be utilized as the solvent in which the reaction takes place. In addition, in certain circumstances the templating agent and the ligand containing monodentate functional groups can be identical. An example of a templating agent which is a ligand containing monodentate functional groups is pyridine.

The preparation of the MOF can be carried out in either an aqueous or non-aqueous system. The solvent can be polar or nonpolar, and the solvent can be a templating agent, or the optional ligand containing a monodentate functional group. Examples of non-aqueous solvents include n-alkanes, such as pentane, hexane, benzene, toluene, xylene, chlorobenzene, nitrobenzene, cyanobenzene, aniline, naphthalene, naphthas, n-alcohols such as methanol, ethanol, n-propanol, isopropanol, acetone, 1,2,-dichloroethane, methylene chloride, chloroform, carbon tetrachloride, tetrahydrofuran, dimethylformamide, dimethylsulfoxide, thiophene, pyridine, ethanolamine, triethylamine, ethylenediamine, and the like.

To form large single crystals of microporous materials, suitable for single crystal x-ray structural characterization, the solution reaction can be performed in the presence of viscous materials, such as polymeric additives. Specific additives can include polyethylene oxide, polymethylmethacrylic acid, silica gels, agar, fats, and collagens, which can aid in achieving high yields and pure crystalline products. The growth of large single crystals of microporous materials leads to unambiguous characterization of the microporous framework. Large single crystals of microporous materials can be useful for magnetic and electronic sensing applications.

### Present Methods

Provided herein are methods of making an adsorbent bed comprising the steps of: (a) mixing a metal-organic framework in powder form in a liquid to produce a suspension; (b) providing a monolith; (c) dip-coating the monolith in the colloidal suspension to produce a metal-organic framework composite having at least one metal-organic framework coating layer deposited on and bound to the monolith; and (d) drying the metal-organic framework composite to produce an absorbent bed having a BET surface area of about 1 m²/g to about 300 m²/g and pore size between about 1 nm and about 50 nm.

As described herein, the step of mixing a metal-organic framework with the liquid can produce a suspension or a colloidal suspension that useful in applying the metal-organic framework coating layer onto the monolith. The coating is then applied to the monolith by dip-coating, wash-coating, or solvothermal deposition to produce the metal-organic framework composite having at least one metal-organic framework coating layer deposited on the monolith. The monoliths can be coated with multiple layers of the same or different metal-organic frameworks to provide composites that are particularly useful as adsorbent beds and micro-reactors. In additional to coating monoliths, coating a planar substrate with the suspension can be useful in producing high surface area supports or rolled-up foils.

More particularly, the present methods can also comprise the steps of: (a) mixing a metal-organic framework in powder form in a liquid to produce a colloidal suspension; (b) providing a monolith; (c) dip-coating the monolith in the colloidal suspension to produce a metal-organic framework composite having at least one metal-organic framework coating layer deposited on and bound to the monolith; and (d) drying the metal-organic framework composite to produce an absorbent bed having a comparative BET surface area of about 40% to about 100% relative to the metal-organic framework monolith and a pore size between about 1 nm and about 50 nm.

To apply the coating onto the monolith by wash coating, a metal-organic framework powder is mixed in a liquid to produce a suspension. The metal-organic framework powder is between about 10 wt. % to about 90 wt. %, about 20 wt. % to about 80 wt. %, about 25 wt. % to about 75 wt. % and/or about 30 wt. % to about 50 wt. % of the suspension and the suspension does not comprise an acid. The suspension is washed onto the substrate to produce a metal-organic framework composite having a metal-organic framework coating layer deposited onto a monolith. The metal-organic composite can then be heated with one or more zeolite to adhere the metal-organic framework coating to the monolith. The resulting metal-organic framework composite has a BET surface area of between about 5 m²/g and about 100 m²/g or 1 m²/g and about 300 m²/g, and/or a comparative BET surface area between about 40% to about 100% relative to the metal-organic framework monolith, together with pore sizes between about 1 nm and about 50 nm.

In addition, metal-organic framework composites can be made via thermal deposition. Here, the metal-organic framework powder is mixed with a liquid to form the metal-organic framework coating. The metal-organic framework coating is then applied to a monolith by thermal deposition to produce a metal-organic framework composite. The metal-organic framework coating comprises a percent by weight (wt. %) of metal-organic framework in the liquid in the range of about 30 wt. % to about 60 wt. %.

Optionally, in any of the methods described herein, the metal-organic framework composite can be dried at a temperature less than about 250° F. to produce the metal-organic framework composite.

In an aspect, the metal-organic framework is HKUST-1, the liquid is ethanol, and the monolith is alumina wash coated cordierite. In an aspect, the metal-organic framework is Mg-MOF-74, the liquid is ethanol, and the monolith is a ceramic. In an aspect, the methods further comprise the step of maturing the metal-organic framework composite at a temperature of about 40° C. to about 150° C. for a period of about 30 minutes or greater. In an aspect, the methods further comprise the step of calcining the metal-organic framework composite at a temperature of about 100° C. to about 300° C. for a period of about 1 hour or greater.

In an aspect, the methods further comprise washing the metal-organic framework composite with an optional solvent. In an aspect, the optional solvent is selected from the group of water, methanol, ethanol, N,N-dimethylformamide, acetone, diethylether, acetonitrile, ketones, amides, esters, ethers, nitriles, aromatic hydrocarbons, aliphatic hydrocarbons, and combination(s) thereof. In an aspect, the adsorbent bed is a channel reactor for gases and fluids.

In an aspect, the monolith is selected from the group of ceramic, metal, polymeric substrate and/or cellulosic fiber. In an aspect, the monolith is ceramic. In an aspect, the polymeric substrate comprises polyvinyl amide, polyacrylate, polymethacrylate, polycarbonate, polyamide, polyester, polyether, polyvinyl amine, polyvinyl alcohol, poly(vinyl ester), polyamide, poly(amic acid) and/or combination(s) thereof. In an aspect, the liquid comprises polyvinyl acetate and water, and the ratio of polyvinyl acetate to water is between about 1:1 to about 1:3.

In an aspect, the metal-organic framework is selected from the group of HKUST-1, UiO-66, ZIF-8, ZIF-7, MIL-100, MOF-74, M₂(m-dobdc), MOF-274, Cu(Qc)₂ and combination(s) thereof.

Further provided herein are channel reactors for gases and fluids comprising one or more layers of a metal-organic framework coating(s) deposited on and/or bound to a monolith to yield a metal-organic framework composite having a BET surface area of about 5 m²/g to about 100 m²/g and/or a comparative BET surface area of about 1% to about 10% relative to the metal-organic framework monolith, and pore size between about 1 nm and about 50 nm. In an aspect, the monolith of the channel reactor is cordierite. In an aspect, the cordierite is alumina wash coated.

### Monolith

The present monolith can be a substrate of monolithic or honeycomb structure. The monolith can be made of a single type of material or different materials, such materials comprising a ceramic, a metal, or can be a polymeric substrate or a cellulose fiber. For example, the monolith can comprise one or more of the following ceramics: cordierite, alumina, cordierite-α alumina, silicon nitride, zircon mullite, spodumene, alumina-silica magnesia, zircon silicate, sillimanite, magnesium silicates, zircon, petalite, aluminosilicates, and combinations thereof. In an aspect, the ceramic monolith is made of cordierite, alumina, or a combination thereof.

The monolith can comprise aluminum, titanium, stainless steel, a Fe-Cr alloy, or a Cr−Al—Fe alloy in the form of a sheet, mesh, foil, flakes, powder, wire, rod, or combinations thereof. In an aspect, the monolith comprises aluminum, stainless steel, Cr—Al—Fe alloy, or combinations thereof in the form of a sheet, mesh, or foil. In an aspect, the monolith comprises between about 80 wt. % to about 97 wt. % alumina blended with between about 1 wt. % to about 10 wt. % silica and/or between about 1 wt. % to about 5 wt. % oxide selected from the group of silica, titania, magnesia and calcium oxide.

The monolith can comprise polymers and/or copolymers of polyolefin(s), polyester(s), polyurethane(s), polycarbonate(s), polyetheretherketone(s), polyphenylene oxide(s), polyether sulfone(s), melamine(s), polyamide(s), polyacrylates, polystyrenes, polyacrylonitriles, polyimides, polyfurfural alcohol, phenol furfuryl alcohol, melamine formaldehydes, resorcinol formaldehydes, cresol formaldehyde, phenol formaldehyde, polyvinyl alcohol dialdehyde, polycyanurates, polyacrylamides, various epoxies, agar, and agarose, or combinations thereof. In an aspect, the plastic monolith can be made of polymers and/or copolymers of polyolefin, polyester, polyurethane, melamine, polypropylene, or polyamide.

The monolith can comprise cellulosic fibers (i.e., paper). The monolith can be a ceramic pellet or a carbon pellet. The monolith can be a planar substrate or a substrate made by layering corrugated metal foil and corrugated plastic sheets, respectively.

The choice of monolith will depend the desired properties of monolith composite. For example, in applications where reducing the weight of the system is critical, or where the pressure drop is critical, metallic and cellulosic fiber honeycombs can offer advantages compared to ceramic honeycombs. In applications where heat transfer is critical, metallic honeycombs can offer advantages compared to the ceramic.

### Polymeric Binder

The metal-organic framework coating layer can optionally comprise one or more polymeric binders. The polymeric binder can be a polar or nonpolar polymer and include homopolymers and copolymers of esters, amides, acetates, anhydrides, imides, ethers, amic acids, vinyls, acrylics, copolymers of a C₂ to C₂₀ olefin, such as ethylene and/or propylene and/or butene with one or more polar monomers, such as acetates, anhydrides, esters, alcohol, and/or acrylics. Further examples of polymeric binders include polyesters, polyamides, ethylene vinyl acetate copolymers, polyvinyl chloride, polyvinyl alcohol (PVA), polyvinyl acetate, mixtures of polyvinyl alcohol and acetate, polyvinyl amine, polycellulose ethers or derivatives thereof. In an aspect, the polymeric binder comprises polyvinyl alcohol or a derivative thereof, such as polyvinyl alcohol, polyvinyl acetate, polyvinyl butyrate, or polyvinyl propionate.

The polymeric binder can be selected from the group consisting of polyethylene, polypropylene, polyolefin copolymers, polyisoprene, polybutadiene, polybutadiene copolymers, chlorinated rubber, nitrile rubber, polychloroprene, ethylene-propylene-diene elastomers, polystyrene, polyacrylate, polymethacrylate, polyacrylonitrile, poly(vinylesters), poly(vinylhalides), polyamides, cellulosic polymers, polyimides, acrylics, vinyl acrylics and styrene acrylics, polyvinyl alcohol, thermoplastic polyesters, thermosetting polyesters, poly(phenylene oxide), poly(phenylene sulfide), fluorinated polymers such as poly(tetrafluoroethylene)poly vinylidene fluoride, poly(vinylfluoride) and chloro/fluoro copolymers such as ethylene chlorotrifluoro-ethylene copolymer, polyamide, phenolic resins and epoxy resins, polyurethane, silicone polymers, and combinations thereof.

In an aspect, the polymeric binder is a polymer blend of two or more polymers. Polymeric binders can include a mixture of polymers in which a first polymer is present at a percent by weight (wt. %) of the polymer mixture in a range of about 10 wt. % to about 99 wt. %, such as 20 wt. % to 95 wt. %, 30 wt. % to 90 wt. %, 40 wt. % to 90 wt. %, or 50 wt. % to 90 wt. %, where the balance of the weight is a second polymer or a combination of polymers. In an aspect, the polymeric binder comprises the polymer blend of polyvinyl alcohol and polyvinyl acetate.

### Optional Additives

Additionally, the metal-organic framework coating layer can comprise additives such as fillers, antioxidants (e.g., hindered phenolics such as IRGANOX™ 1010 or IRGANOX™ 1076 available from Ciba-Geigy), inhibitors of photo-oxidation (e.g., hindered amine light stabilizers, HALS, such as TINUVN® 123 available from BASF, phosphites (e.g., IRGAFOS™ 168 available from Ciba-Geigy), anti-cling additives, tackifiers, such as polybutenes, terpene resins, aliphatic and aromatic hydrocarbon resins, alkali metal and glycerol stearates, and hydrogenated rosins, UV stabilizers; heat stabilizers, anti-blocking agents, release agents, anti-static agents, pigments; colorants, dyes, waxes, silica, fillers, and talc.

Other optional additives include silica, such as precipitated silica and silica originating from by-products such as fly-ash, for example silica-alumina, silica-calcium particles, or fumed silica. In an aspect, the silica is particulate matter and has an average particle size of 10 μm or less, such as 5 μm or less, or 1 μm or less. In an aspect, the silica is amorphous silica.

Other additives that can be optionally included in the metal-organic coating layer include inorganic compounds, such as titanium dioxide, hydrated titanium dioxide, hydrated alumina or alumina derivatives, mixtures of silicon and aluminum compounds, silicon compounds, clay minerals, alkoxysilanes, and amphiphilic substances. Additives can also include any suitable compound use for adhesion of powdery materials, such as oxides, of silicon, of aluminum, of boron, of phosphorus, of zirconium and/or of titanium. Additionally, additives can include oxides of magnesium and of beryllium. Furthermore, tetraalkoxysilanes can be used as additives, such as tetramethoxysilane, tetraethoxysilane, tetrapropoxysilane and tetrabutoxysilane, the analogous tetraalkoxytitanium and tetraalkoxyzirconium compounds and trimethoxy-, triethoxy-, tripropoxy- and tributoxy-aluminum.

### Suspension

As described above, the present methods include mixing and/or suspending the metal-organic framework in a liquid to produce a suspension. In the present methods, the metal-organic framework remains dispersed in the liquid. Preferred organic solvents include ethanol, methanol, DMF (dimethylformamide), and water. In an aspect, the solvent can be a mixture of two or more organic solvents. The suspension can be in the form of a liquid or a gas.

The weight percent of metal-organic framework to organic solvent is variable for each metal-organic framework. The various weight percentages of MOF to organic solvent will depend on particle size, solvent solubility, pore volume, viscosity and colloidal stability of the metal-organic framework in the liquid. The suspension can have a pH between about 5 and about 9, or between about 6 and about 8.

MOF composites having a metal organic framework layer can optionally undergo maturation, such as drying or settling of the MOF composite. Drying temperatures cannot exceed of 250° F. and can be between about 5° F. and about 250° F., about 20° F. and about 200° F., or about 20° F. to about 150° F. The maturation can take place for a duration of about 1 min to about 72 hours, such as about 30 min to about 72 hours, about 1 hour to about 48 hours, or about 1 hour to about 24 hours. In an aspect, the maturation can be carried out in air or humidified air with a relative humidity of 20% to 100%, such as 70% to 100%. The treatment with humidified gas can allow for hydration of the material, which can be beneficial to setting certain polymeric binders. In an aspect, the maturation can be carried out in air or inert gas that is dehumidified, such as air with a relative humidity of 0% to 10%, or of 0% to 5%.

The MOF composites can optionally undergo activation. Activation can take place at temperatures of about 50° F. to about 250° F. Activation can take place for a duration of about 1 hour (“h”) to about 6 h, such as about 1 h to about 4 h. Activation can aid in removal of solvent. The activation can take place in air, inert gas, or a mixture containing oxygen. Additionally, activation can take place at reduced or increased pressure, such as in vacuo or pressures greater than atmospheric pressure.

In an aspect, the MOF composite can be calcined under dry air or air with different levels of humidity or they are heat-treated in the presence of a gas mixture including an inert gas, such as nitrogen and/or oxygen. In an aspect, the gas mixture used can include 5 vol. % or more, such as 10 vol. % or more oxygen. In an aspect, the gas mixture is free of or substantially free of oxygen and include only inert gases. The calcination temperature can be from about 50° C. to about 250° F.

### Properties of MOF Composites

MOF composites prepared with the present methods can have a BET surface area (measured using ASTM D3663) of about 5 m²/g to about 200 m²/g, about 5 m²/g to about 150 m²/g, about 5 m²/g to about 100 m²/g, about 5 m²/g to about 75 m²/g, about 20 m²/g to about 100 m²/g, about 40 m²/g to about 100 m²/g, about 20 m²/g to about 80 m²/g, or about 30 m²/g to about 70 m²/g.

Additionally, the MOF composites prepared with the present methods can have a comparative BET surface area of about 1% to about 10%, such as from about 1% to about 9%, or from about 2% to about 8% (measured using ASTM D3663) of the pristine MOF.

The MOF composites coated with MOFs prepared with the present methods can have an average pore width (measured using ASTM D4365) between about 1 nm and about 2.5 nm, between about 1 nm and about 2.2 nm, between about 1 nm and about 2 nm, between about 1.2 nm and about 2.5 nm, between about 1.5 nm and about 2.5 nm, or between about 1.5 nm and about 2 nm.

The MOF composites comprise between about 1 wt. % to 10 wt. %, 2 wt. % to 8 wt. % or 3 wt. % to 6 wt. % of the metal-organic frameworks. In any aspect, the MOF composites can comprise 3.15 wt. %, 4.5 wt. % or 6.1 wt. % of the metal-organic frameworks.

### Applications

The present metal-organic framework composites are useful in any application where a porous body or a body with channels provides an advantage over solid bodies or powders and the operating temperature does not exceed 400° C. and the operating pressure does not exceed 150 bar. In particular, these applications can include, but are not limited to, channel reactors, adsorption beds, desiccants or other fluid storage, ion exchangers, and molecular sieves.

Additionally, the MOF composites can be used to catalyze various reactions where the presence of channels and/or pores incorporated therein are known or believed to increase the activity and/or selectivity and/or yield of the reaction.

Another application is the storage of compounds, especially of gaseous compounds. The pore size and porosity of the MOF composites can allow for excellent storage or sequestration of gaseous compounds, such as CO₂, CH₄, or H₂, and separations of gases, all of which are of particular interest in the energy industry.

The features of the invention are described in the following non-limiting examples below.

### EXAMPLE

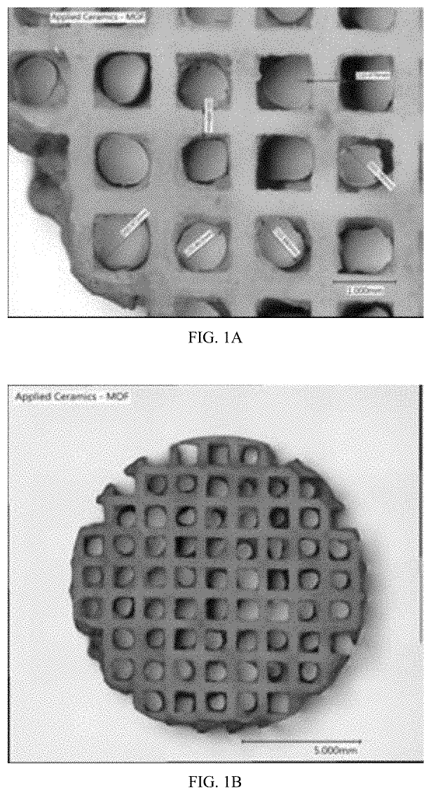

Coating of cordierite monoliths was completed by dip-coating them in a suspension of metal-organic framework (MOP). Two metal-organic frameworks were used: HKUST-1 (Cu3(btc)2; btc3-=1,3,5-benzenetricarboxylate); and Mg-MOF-74 (Mg2(dobdc); dobdc4-=2,5-dihydroxy-1,4-benzenedicarboxylate). The suspension for the HKUST-1 coating was prepared by suspending HKUST-1 powder in ethanol (40 wt. % HKUST-1 in ethanol). The monolith used was one inch having a 400 channels per square inch (“CPSI”) with 55% OFA. The monolith was dip-coated twice, with drying steps after each dip-coating step, to achieve the metal-organic framework monolith having the HKUST-1 coating layer shown in FIG. 1A and FIG. 1B. The HKUST-1 metal-organic framework coating is shown in these figures in blue. The figures further show relatively uniform thickness throughout the monolith. As shown, the monolith has square channels with a thickness of layering in the right angles of the channel, resulting in the channels being “rounder” after dip-coating.

A suspension for dip-coating HKUST-1 was prepared by suspending HKUST-1 powder in ethanol (40 wt. % HKUST-1 in ethanol). The Brunauer-Emmett-Teller surface area (referred to herein as “BET surface area”) of the metal-organic framework composite was 42 m²/g, which includes the mass of the monolith itself. The monolith itself has effectively no surface area, so the observed surface area of the metal-organic framework composite can be entirely attributed to the MOF coating. The BET surface area of the MOF, HKUST-1, is approximately 1500 m²/g. The metal-organic framework coating was 6.1% of the mass of the overall metal-organic framework composite. Given the BET of the pure metal-organic framework, the expected BET surface area is 92 m²/g for the composite, assuming the metal-organic framework has surface area which is the same order of magnitude as the 42 m²/g we see experimentally. Furthermore, pore size as calculated from the N₂ isotherm indicates the average pore width of the monolith composite was 1.697 nm, which is the pore width of the metal-organic framework HKUST-1, indicating that the porosity is coming from the metal-organic framework, HKUST-1 and has been preserved in the present methodology.

A coating of the metal-organic framework, HKUST-1 in ethanol was also dip-coated onto an alumina monolith having square channels and 400 channels per square inch. The monolith had a BET surface area of 26 m²/g and an average pore width of 1.622 nm, again consistent with an HKUST-1 coating onto the monolith. The metal-organic framework composite yielded 4.5 wt. % of HKUST-1, which gives an expected BET of 67 m²/g, again close to the experimentally-obtained value.

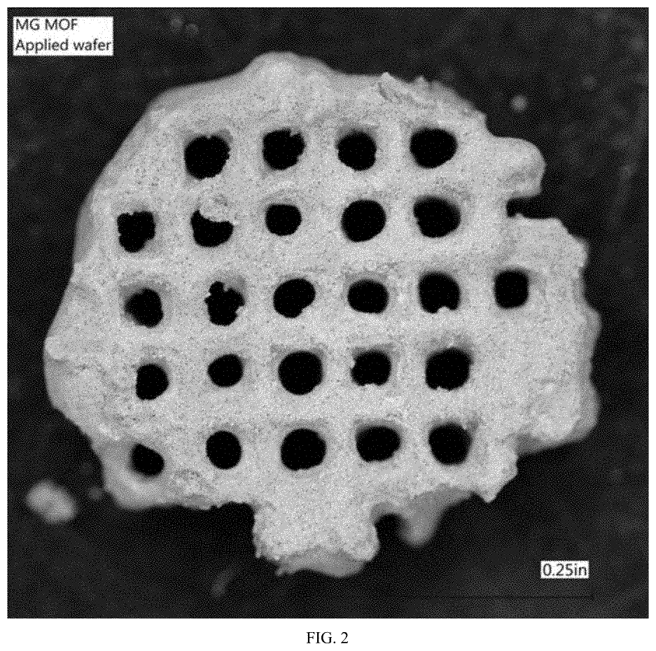

Further dip-coating experiments were performed with different monoliths including Mg-MOF-74 coated onto an Applied Ceramics monolith. FIG. 2 is a micrograph of that metal-organic composite.

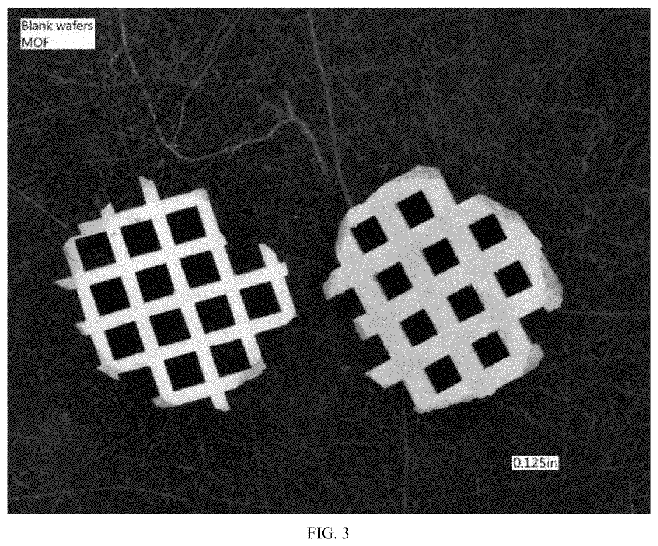

FIG. 3 shows the two monoliths prior to coating. The color change and change in thickness of the monoliths indicate the metal-organic coating was successful when compared to the above images of the coated monoliths.

1-26. (canceled)

27. A method of making a metal-organic framework composite comprising the steps of:
mixing a metal-organic framework with a liquid to produce a suspension, wherein the liquid is ethanol; and
applying the suspension to a monolith by dip-coating, wash-coating, or solvothermal deposition to produce a metal-organic framework composite having at least one metal-organic framework coating layer deposited on the monolith.

28. The method of claim 27, further comprising the steps of:
mixing the metal-organic framework in powder form in the liquid to produce a colloidal suspension;
providing the monolith;
dip-coating the monolith in the colloidal suspension to produce a metal-organic framework composite having at least one metal-organic framework coating layer deposited on and bounded to the monolith; and
drying the metal-organic framework composite to produce the metal-organic framework composite having a BET surface area of about 5 m²/g to about 100 m²/g and pore size between about 1 nm and about 50 nm.

29. The method of claim 27, further comprising the steps of:
mixing the metal-organic framework in powder form in the liquid to produce a colloidal suspension;
providing the monolith;
dip-coating the monolith in the colloidal suspension to produce a metal-organic framework composite having at least one metal-organic framework coating layer deposited on and bounded to the monolith; and
drying the metal-organic framework composite to produce an absorbent bed and/or micro-reactor having a comparative BET surface area of about 1% to about 10% of the pristine metal-organic framework and a pore size between about 1 nm and about 50 nm.

30. The method of claim 27, further comprising the steps of:
suspending the metal-organic framework powder in the liquid to produce a suspension, wherein the metal-organic framework powder is between about 10 wt. % to about 90 wt. % of the suspension and the suspension does not comprise an acid;
washing the suspension onto the monolith to produce a metal-organic framework composite comprising a metal-organic framework coating deposited onto a monolith; and
heating the metal-organic framework composite with one or more zeolite to adhere the metal-organic framework coating to the monolith, wherein the metal-organic framework composite has a BET surface area of about 5 m²/g to about 100 m²/g and/or a comparative BET surface area of about 1% to about 10% of the pristine metal-organic framework, and pore size between about 1 nm and about 50 nm.

31. The method of claim 27, further comprising the steps of:
mixing the metal-organic framework powder with the liquid to form a metal-organic framework coating;
applying the metal-organic framework coating to the monolith by thermal deposition to produce a metal-organic framework composite, wherein the metal-organic framework coating comprises a percent by weight of metal-organic framework in the liquid in the range of about 30 wt. % to about 60 wt. %; and
drying the metal-organic framework composite at a temperature below 250° C. to produce the metal-organic framework composite having a BET surface area of about 1 m²/g to about 300 m²/g and/or a comparative BET surface area of about 1% to about 10% of the pristine metal-organic framework, and pore size between about 1 nm and about 50 nm.

32. The method of claim 31, wherein the metal-organic framework composite has a BET surface area of about 1 m²/g to about 100 m²/g.

33. The method of claim 27, wherein the monolith is selected from the group of ceramic, metal, polymeric substrate and/or cellulosic fiber.

34. The method of claim 33, wherein the monolith is ceramic.

35. The methods of claim 33, wherein the polymeric substrate comprises polyvinyl amide, polyacrylate, polycarbonate, polyamide, polyester, polyether, polyvinyl amine, polyvinyl alcohol, polyvinyl ester, and/or combination(s) thereof.

36. The method of claim 27, wherein the metal-organic framework is HKUST-1, and the monolith comprises alumina.

37. The method of claim 27, wherein the metal-organic framework is Mg-MOF-74, and the monolith is a ceramic.

38. The method of claim 27, wherein the metal-organic framework is selected from the group of HKUST-1, UiO-66, ZIF-8, ZIF-7, MIL-100, MOF-74, M₂(m-dobdc), MOF-274, Cu(Qc)₂ and combination(s) thereof.

39. The method of claim 27, further comprising the step of maturing the metal-organic framework composite at a temperature of about 40° C. to about 150° C. for a period of about 30 minutes or greater.

40. The method of claim 27, further comprising the step of heat-treating the metal-organic framework composite at a temperature of about 100° C. to about 300° C. for a period of about 1 hour or greater.

41. The method of claim 27, further comprising washing the metal-organic framework composite with an optional solvent.

42. The method of claim 41, wherein the optional solvent is selected from the group of water, methanol, ethanol, dimethylformamide, acetone, diethylether, acetonitrile, ketones, amides, esters, ethers, nitriles, aromatic hydrocarbons, aliphatic hydrocarbons, and combination(s) thereof.

43. The method of claim 27, wherein the suspension includes from about 20 wt. % to about 70 wt. % solids, based on the total weight of the suspension.

44. The method of claim 27, wherein the composite is an absorbent bed or a channel reactor for gases and fluids.

45. The method of claim 27, wherein the monolith comprises between about 80 wt. % to about 97 wt. % alumina blended with between about 1 wt. % to about 10 wt. % silica and/or between about 1 wt. % to about 5 wt. % oxide selected from the group of silica, titania, magnesia and calcium oxide.

46. A channel reactor for gases and fluids comprising at least one layer of a metal-organic framework coating deposited on and bounded to a monolith to yield a metal-organic framework composite, the metal-organic framework composite having a BET surface area of about 5 m²/g to about 100 m²/g and/or a comparative BET surface area of about 1% to about 10% of the pristine metal-organic framework, and pore size between about 1 nm and about 50 nm.

47. The channel reactor of claim 46, wherein the monolith is cordierite.

48. The channel reactor of claim 47, wherein the monolith comprises alumina.

49. The channel reactor of claim 46, wherein the reactor or bed can adsorb and/or absorb between about 5 to about 120 grams CO₂ per liter.
